(19) United States
(12) Patent Application Publication
(10) Pub. No.: US 2012/0186099 A1
(43) Pub. Date: Jul. 26, 2012

(54) CONNECTION SYSTEMS FOR REFRIGERATION FILTER DRYER UNITS AND METHODS FOR THEIR MANUFACTURE

(75) Inventors: Shabbir Attarwala, Simsbury, CT (US); Tim Graver, Cheshire, CT (US); James M. Comeau, Newington, CT (US); John J. Cocco, Vernon, CT (US)

(73) Assignee: Henkel Corporation, Rocky Hill, CT (US)

(21) Appl. No.: 13/399,255

(22) Filed: Feb. 17, 2012

Related U.S. Application Data
(63) Continuation-in-part of application No. 12/358,798, filed on Jan. 23, 2009.

(51) Int. Cl. F26B 25/00; B23P 19/04

(52) U.S. Cl. 34/242; 29/428

(57) ABSTRACT

A high pressure connection and method for making a high pressure connection between an existing filter dryer unit and a refrigeration system using a radically curable composition. The radically curable composition can be an anaerobically curable composition.

### FIELD

The present disclosure relates generally to new and improved components for securing a filter dryer to a refrigeration system and methods for their use.

### BRIEF DESCRIPTION OF RELATED TECHNOLOGY

Refrigeration systems that rely on a refrigerant phase change to provide a temperature differential are used in numerous applications including commercial and residential refrigeration, freezing, air conditioning and heating systems. Refrigeration systems typically include a compressor, a condenser, a metering device and an evaporator all fluidly connected and containing a refrigerant. The compressor takes low pressure refrigerant vapor and pressurizes the vapor. Refrigeration compressors can be of the reciprocating piston, screw, rotary, scroll or centrifugal type. The condenser takes high pressure refrigerant vapor from the compressor, removes heat from this vapor and condenses the vapor to a pressurized liquid. The metering device modulates or restricts flow of the liquid refrigerant to the evaporator. Metering devices range from a capillary tube as used in residential refrigerators to a modulating thermostatic expansion valve used in more sophisticated systems. The evaporator allows liquid refrigerant to absorb heat and evaporate to a gas. The refrigeration system can also include accessories such as refrigerant filter dryer units, refrigerant accumulators and system access points useful to check internal pressure and add refrigerant, etc.

The refrigerant is a material that can change between liquid and vapor phases under specified conditions. Refrigerants include the fluorinated hydrocarbon refrigerants such as R-20 (CHCl₃), R-22 (CHF₂CL), R-22B1 (CHBrF₂), R-32 (CH₂F₂), R-125 (CHF₂CF₃), R-134A (CH₂FCF₃), R-143A (CH₃CF₃), R-152A (CH₃CHF₂), R-404A (a zeotropic mixture of R-125 and R-143A), R-407C (a zeotropic mixture of R-32, R-125 and R-134A), R-410A (a zeotropic mixture of R-32 and R-125), R-502 (an azeotropic mixture of R-22 and R-115), R-507 (an azeotropic mixture of R-125 and R-143A), R-1120 (CHClCCl₂) and R-C316 (C₄Cl₂F₆). Refrigerants also include non-fluorinated refrigerants such as ammonia (NH3), R-290 (propane), R-600 (butane) and R-600A (isobutene).

Many high pressure connections exist between and among the compressor, condenser, metering device, evaporator, tubing and accessories. To be commercially acceptable for use in a refrigeration system each connection has several properties. For instance, the connections must not leak refrigerant or refrigerant oil for the life of the system. The connections must withstand the internal working pressure and maximum burst pressure of the contained refrigerant without failure. Earlier refrigeration systems had working pressures of about 200 pounds per square inch. However, different refrigerants have recently come into use to meet evolving environmental standards and high pressure connections in these new refrigeration systems need to be designed with those different refrigerants and use conditions in mind. The connections must withstand extended periods of flexing, vibration and thermal cycling without fracture or failure. The connections must be inert to internal environmental conditions such as exposure to refrigerant or refrigerant oil. A connection material that washes off or dissolves during use can undesirably redeposit in other parts of the refrigeration system leading to compromises in the integrity of the refrigeration system, inefficiencies in operation, aesthetic problems and even system failures. The connections must be resistant to external environmental conditions such as exposure to cleaning chemicals. The connections must be useful with refrigeration system components and tubing of different sizes and materials. The connections must be useful with refrigeration system components having large gaps, for example 0.01 inches to 0.05 inches, between the assembled components. The connections are desirably fabricated quickly. Some assembly operations form high pressure connections in less than ten seconds. After assembly the connections are desirably capable of use quickly. Some assembly operations pressurize and start the refrigeration system less than one hour after the connections are formed. The connections are desirably made by workers with minimal training using inexpensive equipment. It is desirable that the connections can be fabricated without using hazardous materials or hazardous processes. Naturally it is desirable that the connection can be fabricated at a low cost. The connections should also be repairable without special equipment.

Typically, smaller refrigeration systems use two processes to form high pressure connections: high temperature fusion joining processes such as welding or brazing and low temperature mechanical joining processes that rely on swaging or plastic deformation of the joined components. However, despite a long period of use neither of these processes is completely satisfactory for a high pressure connection. High temperature processes require expensive automated equipment or skilled workers. High temperature processes require use of hazardous or flammable fluxes. Only selected brazing filler materials are useful in refrigeration system connections. Brazing a high pressure connection having an aluminum member is, at best, difficult and requires specialized equipment and brazing materials. The high temperatures and open flames used in fusion joining processes are dangerous when flammable refrigerants are present. Low temperature swaging processes such as the LOKRING process permanently deform the attached parts. This prevents disassembly of the joined parts and makes subsequent repair of a damaged connection difficult. Swaging processes also add expensive components to the connection and require use of expensive equipment. The swaging components must be selected based on connection member size, thereby requiring a user to maintain a plurality of connectors for each connection member size or limit the connection sizes used. Workers must be trained to correctly use the swaging equipment and swaging process. Even with training, swaging of parts having large gaps or swaging of small diameter parts is difficult at best. It is not usually possible to form a swaged connection during a field repair.

U.S. Pat. No. 3,687,019 discloses a two part tube joint construction for a hermetic compressor. This tube joint construction relies on an interference fit between parts, uses a mechanical crimp between the parts and an anaerobic sealant. Even with an interference fit between parts, a mechanical crimp and anaerobic sealant the tube joint construction appears to be limited to an internal pressure of only up to 500 pounds per square inch.

U.S. Pat. No. 3,785,025 also discloses a two part tube joint construction for a hermetic compressor. This tube joint construction relies on an interference fit between parts, uses a mechanical crimp between the parts and an anaerobic sealant and suffers from the same internal pressure deficiencies as those in the '019 patent.

U.S. Pat. No. 6,494,501 discloses a multiple part joint construction including a double wall pipe connector. This pipe connector requires two spaced walls defining a gap between which a tube and sealant is disposed. Such a connector is difficult to form, limited to use with only one tube diameter and adds an additional part and operation to the formation of a tubing connection.

Most refrigeration systems include filter dryer units for the refrigerant. The filter portion filters particles as small as 20 microns from the refrigerant. If not removed particles can clog internal passages of the refrigeration system and lead to breakdown of the compressor. The dryer portion removes contaminants such as acids and moisture from the refrigerant by passing refrigerant through a bed of drying material, such as zeolites, molecular sieve, silica gel or activated alumina. If not removed water can freeze in the system, lessening efficiency of the refrigeration system or in some cases completely blocking refrigerant flow within the system, leading to system shutdown. Acids will cause harmful corrosion within the system.

Each year millions of filter dryer units are manufactured for use in new refrigeration systems. Many additional filter dryer units are manufactured and held in storage for repair of existing refrigeration systems. Filter dryer units are manufactured by deep drawing of copper or aluminum based alloys into an elongated shell with a closed end and an open end. Filter and adsorbent media is placed in the open shells and the open ends are joined to form the finished unit. Deep drawing requires a different complex and expensive mold for each different filter dryer configuration. Changing the filter dryer unit requires either an expensive new mold or expensive reworking of an existing mold. There is reluctance on the part of manufacturers to change to new filter dryer designs because of the expense of reworking old molds and obtaining new molds.

Filter dryer units typically have one or more connections through which refrigerant flows. The connections may vary in diameter from larger diameter tubes to small diameter capillaries. There is very little overlap from which the tubing can be securely attached to the filter shell. This is especially true for the small diameter capillary tubes connection to a filter shell. Adhesive bonding of the connection tubing to the shell is not considered commercially viable due to this lack of overlap. Redesign of filter shells to add additional overlap length is not preferred due to cost. For this reason filter dryer units are typically connected to the rest of the refrigeration system by fusion processes such as brazing.

There remains a need for a new type of high pressure connection useful to secure existing and future filter dryer unit designs, including those with little overlap for tubing connections, to a refrigeration system.

### SUMMARY

The present application provides broadly a method of making a high pressure connection between existing refrigeration filter dryer units and a refrigeration system using a radically curable composition.

One aspect thereof provides a method of adapting a conventionally designed filter dryer unit to a high pressure connection in a refrigeration system using a radically curable composition.

As used herein a high pressure connection is a connection that can retain gas or liquid at a maximum pressure of at least 1,200 pounds per square inch, advantageously a pressure of at least 1,500 pounds per square inch and more advantageously a pressure of at least 2,000 pounds per square inch under conditions encountered in refrigeration systems. This high pressure connection is advantageously useful securing a filter dryer unit in a refrigeration system.

The high pressure connection may comprise, or alternatively consist essentially of, a coupling, a first distal joint portion disposed within the coupling, a second distal joint portion disposed within the coupling and cured reaction products of a radically curable composition between the coupling and first distal joint portion and the coupling and second distal joint portion. As used herein a “high pressure connection consisting essentially of a coupling, a first distal joint portion, a second distal joint portion and cured reaction products of a radically curable composition” indicates that high pressure connections incorporating other structural elements are not included. Thus, connections that require other structural elements to form a high pressure connection, for example, weld material, threads or threaded interconnection, a ferrule, a driver ring, a lock ring, a swage ring, plastic deformation of the distal joint portions or cured reaction products of epoxy resins alone are disclaimed in this aspect.

The method of this embodiment comprises providing a filter dryer unit having one or more first distal joint portions. Each distal joint portion is generally tubular and includes a substantially uniform cylindrical outer surface free from threads, a substantially uniform cylindrical inner surface free from threads having an inner diameter defining a bore through the first joint portion, and a circumferential end connecting the outer and inner surfaces.

A coupling is provided. The coupling comprises a substantially uniform cylindrical inner surface free from threads defining a bore therethrough. A first end of the bore is sized to accommodate one distal joint portion of the filter dryer unit therein while the opposing second end of the bore is sized to accommodate one distal joint portion of a tube or capillary therein. The bore internal diameter may be different at each end of the coupling.

A tube or capillary having a second distal joint portion at one end is provided. The second distal joint portion is generally tubular and includes a substantially uniform cylindrical outer surface free from threads, a substantially uniform cylindrical inner surface free from threads defining a bore through the member, and a circumferential end connecting the outer and inner surfaces.

A radically curable composition is applied to the distal joint portions and/or the coupling bore. In some embodiments a primer composition is also applied to some or all of these portions.

One distal joint portion of the filter dryer unit is slidingly received within the first end of the coupling bore and one distal joint portion of a tube or capillary is slidingly received in the opposing end of the coupling bore. Typically the distal joint portions are in end to end relationship in the coupling bore. In some variations the second distal joint portion is disposed through the coupling bore and extends into the first distal joint portion bore. In some variations the position of the distal joint portions and coupling are reversed, e.g. the coupling external diameter fits within the distal joint portion bore.

In one variation either or both of the primer composition and curable composition are applied to the distal joint portions after they are slidingly received in the coupler. In this variation the primer composition and/or curable composition would typically be applied adjacent the exposed distal joint region and would flow or wick between the distal joint portions and coupler bore.

In one variation the primer composition and the curable composition are applied as separate beads to the same portion. The separated beads are mixed when the distal joint portions are received in the coupling bore.

The radically curable composition may be anaerobically cured to maintain the distal joint portions within the coupler bore thereby forming the high pressure connection. There is no plastic deformation of the material comprising the first distal joint portion, second distal joint portion or coupling after the step of sliding. Plastic deformation refers to a permanent change in the shape of an object caused by an applied force.

The method can be used to retain gasses or liquid refrigerant at a maximum pressure greater than 1,200 pounds per square inch, advantageously at a pressure greater than 1,500 pounds per square inch and more advantageously at a pressure greater than 2,000 pounds per square inch within the refrigeration system under operating conditions.

The method can be used when the distal joint portions and or coupler are independently selected from copper, aluminum, steel, coated steel and plastic. The method is advantageous when one distal joint portion is aluminum and the other distal joint portion is independently selected from copper, aluminum, steel, coated steel and plastic.

The method can be used when there is a gap up to about 0.05 inches between the distal joint portion outer diameter and coupler inner diameter.

In some embodiments the filter dryer unit and high pressure connection is advantageously used in a refrigerator, a freezer, a refrigerator-freezer, an air conditioner, a heat pump, a residential heating, ventilation and air conditioning (“HVAC”) system, a commercial HVAC system or a transportation HVAC system such as in an automobile, truck, train, airplane, boat, etc.

The curable composition advantageously comprises a (meth)acrylate component. The curable composition may optionally comprise a monofunctional (meth)acrylate. The curable composition advantageously has a free radical cure mechanism and more advantageously has an anaerobic cure mechanism and includes an anaerobic cure-inducing component.

The optional primer composition includes an activator. In some embodiments the primer composition includes a reactive carrier, a polymeric matrix or both.

In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in earlier materials and processes or that are otherwise not necessary to the achievement of the function and/or objective of the present disclosure.

When the word “about” is used herein it is meant that the amount or condition it modifies can vary some beyond the stated amount so long as the function and/or objective of the disclosure are realized. The skilled artisan understands that there is seldom time to fully explore the extent of any area and expects that the disclosed result might extend, at least somewhat, beyond one or more of the disclosed limits. Later, having the benefit of this disclosure application and understanding the embodiments disclosed herein, a person of ordinary skill can, without inventive effort, explore beyond the disclosed limits and, when embodiments are found to be without any unexpected characteristics, those embodiments are within the meaning of the term “about” as used herein.

### BRIEF DESCRIPTION OF THE DRAWINGS

Referring now to the drawings wherein like elements are numbered alike in the several Figures:

FIG. 1 is a schematic representation of a refrigeration system.

FIG. 2 is an exploded, schematic elevational view of portions of two tubular members forming a two part connection.

FIG. 3 is an exploded, schematic, elevational view of portions of two tubular members forming a multiple part connection.

FIG. 4 is a schematic, elevational view of one embodiment of high pressure connections comprising portions of two tubular members bonded to a “U” shaped connector.

FIG. 5 is a perspective view of a two part, high pressure connection comprising an aluminum member and a copper member.

FIG. 6 is a perspective view of a portion of a refrigerator. The arrows illustrate two part, high pressure connections formed according to the method of this disclosure

FIG. 7 is a partial, schematic exploded view of the filter dryer unit high pressure connection.

FIG. 8 is a schematic exploded view of the filter dryer unit high pressure connection.

FIG. 9 is a schematic view of one embodiment of a coupling.

### DETAILED DESCRIPTION

The disclosed high pressure connection is advantageously useful in fluidly connecting an existing filter dryer unit in a refrigeration system.

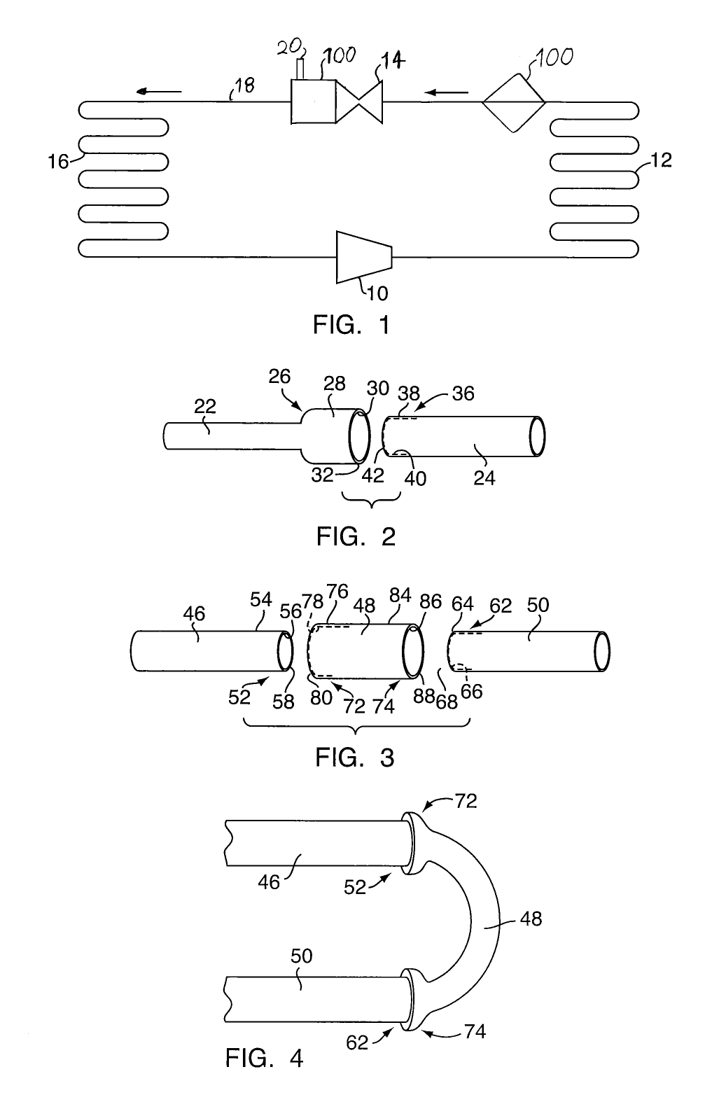

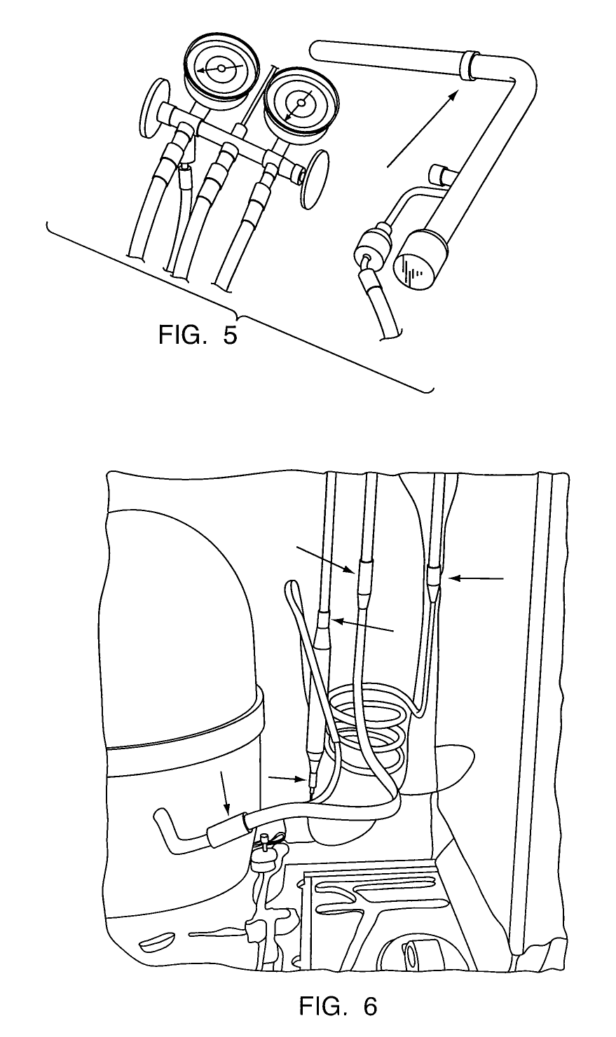

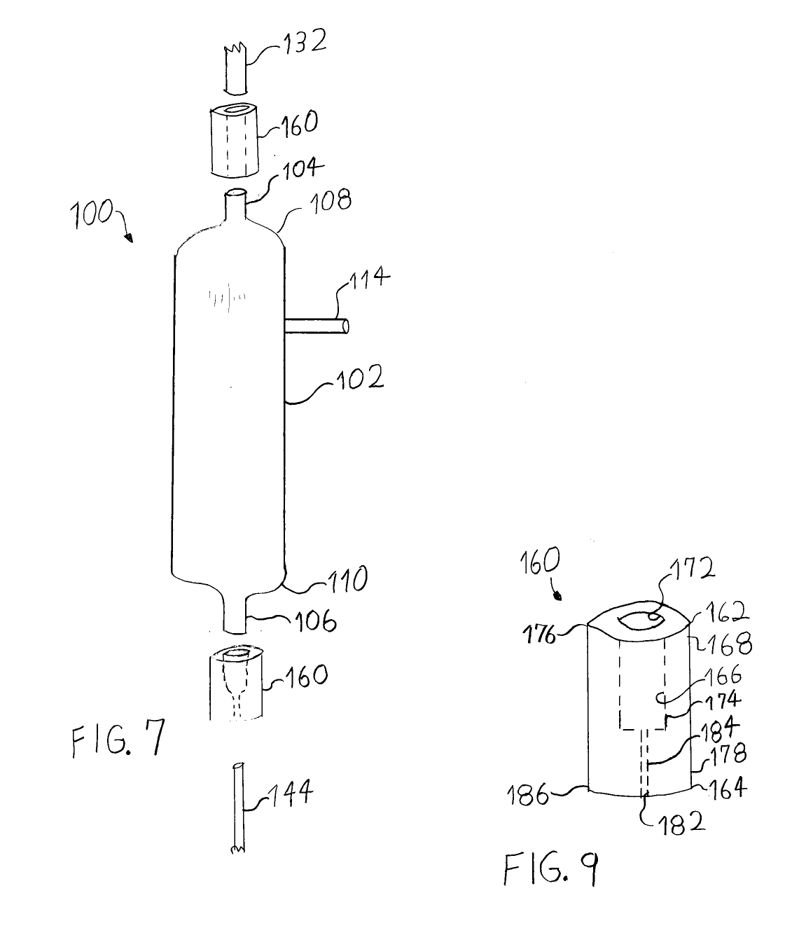

With reference to FIG. 1, some refrigeration systems include a compressor 10, a condenser 12, a metering device 14 including a capillary line 18 regulating refrigerant flow to an evaporator 16 and a charge connection 20 all fluidly connected by tubing and containing a refrigerant. In some variations the metering device 14 may include a filter dryer 100. Alternatively, a filter dryer unit 100 may be fluidly connected within the refrigeration system separately from the metering device. There are a plurality of high pressure connections (not shown for clarity) between, and within, the tubing, compressor, condenser, evaporator and any accessories. The connections are preferably two part connections as exemplified in FIG. 2 although multiple part connections as exemplified in FIG. 3 are known in refrigeration systems. Each two part connection typically comprises two hollow, tubular members 22, 24 with a cured reaction product of a radically curable composition therebetween. The filter dryer unit uses a multiple part connection comprising a coupling.

Each tubular hollow member, connector and coupling is independently comprised of a material, for example copper, aluminum, steel, coated steel and plastic. Coated steel includes a steel member coated with another material, for example a steel member coated with copper plating. In one embodiment one part is comprised of aluminum and joining part is comprised of copper. In one embodiment both joining parts are comprised of aluminum. In one embodiment at least one of the parts is plastic.

Each tubular member typically has a length many times, for example five to ten times or more, its diameter. One tubular member 22 has a distal joint portion 26 including a substantially uniform cylindrical outer surface 28 free from threads, a substantially uniform cylindrical inner mating surface 30 free from threads having an inner diameter and a circumferential end 32 connecting the outer 28 and inner 30 surfaces. The inner diameter does not include any optional chamfer or expansion of the distal joint portion 26 adjacent the end 32. The other tubular member 24 has a distal joint portion 36 including a substantially uniform cylindrical outer mating surface 38 free from threads and defining an outer diameter, a substantially uniform cylindrical inner surface 40 free from threads and a circumferential end 42 connecting the outer 38 and inner 40 surfaces. The outer diameter does not include any optional chamfer or expansion of the distal joint portion 36 adjacent the end 42. The inner diameter of distal joint portion 26 is larger than the outer diameter of distal joint portion 36 to allow distal joint portion 36 to be disposed within distal joint portion 26. Since the members 22, 24 are generally formed without machining, e.g. from purchased tubing or swaged tubing, each member can have a considerable range of distal joint portion diameters. Given this range of diameters the gap between a complementary set of members 22, 24 can be in the range of about 0.001 inches to about 0.05 inches. No interference or press fit between the inner diameter of distal joint portion 26 and the outer diameter of distal joint portion 36 is required to form a high pressure connection.

Surprisingly, it has been found that distal joint portions bonded by the cured reaction product of an anaerobically curable composition can form a leakproof connection that can maintain integrity at pressures of about 1200 pounds per square inch or more, even between distal joint portions having gaps up to 0.05 inches. Use of a primer composition, advantageously a reactive primer composition that can react with the curable composition during curing, may be required to ensure adequate strength within the joint and repeatability from joint to joint.

To prepare a high pressure connection complementary members 22, 24 are provided. The mating surfaces 30, 38 should be clean and free of contamination. Abrasion of one or both mating surfaces may be advantageous. A primer composition is optionally applied to the mating surface 30, 38 of one distal joint portion 26, 36 respectively. A curable composition is applied to a mating surface, typically of the other of the distal joint portion. The smaller diameter distal joint portion 36 is slidingly disposed within the larger diameter distal joint portion 26. Some rotation of the distal joint portions may be beneficial to distribute the primer composition and curable composition around the entirety of the mating surfaces but is not required. The members 22, 24 are held in position for less than about 30 seconds, advantageously less than about 15 seconds and desirably less than about 10 seconds while exposed to conditions appropriate to at least partially cure the composition to allow the at least partially cured composition to maintain the second tubular member distal joint portion within the first tubular member distal joint portion. The composition may be further cured for a short time thereby forming the high pressure, connection between the ends 32, 42 of the distal joint portions. Typical cure times will be less than 60 minutes and advantageously less than 30 minutes before the connection can be pressurized for use.

The high pressure connection will maintain pressure greater than about 1200 pounds per square inch and advantageously greater than about 1500 pounds per square inch and more advantageously greater than about 2000 pounds per square inch after fully curing.

The exterior surface 28 of distal joint portion 26 defines an exterior surface of the high pressure connection and the interior surface 40 of distal joint portion 36 defines an interior surface of the high pressure connection. Plastic deformation in the material of either distal joint portion 26, 36 after disposition of the smaller diameter distal joint portion 36 within the larger diameter distal joint portion 26 is advantageously avoided.

In another embodiment a multiple part connection typically comprises two hollow, tubular members 46, 50 and a hollow connector 48. One tubular member 46 has a distal joint portion 52 including a substantially uniform cylindrical outer surface 54 free from threads, a substantially uniform cylindrical inner surface 56 free from threads having an inner diameter and a circumferential end 58 connecting the outer 54 and inner 56 surfaces. The other tubular member 50 has a distal joint portion 62 including a substantially uniform cylindrical outer surface 64 free from threads and defining an outer diameter, a substantially uniform cylindrical inner surface 66 free from threads and a circumferential end 68 connecting the outer 64 and inner 66 surfaces. The connector 48 has two distal joint portions 72, 74. Distal joint portion 72 includes an outer surface 76 free from threads, an inner surface 78 free from threads and a circumferential end 80. Distal joint portion 74 includes an outer surface 84 free from threads, an inner surface 86 free from threads and a circumferential end 88. The connector 48 is short, for example with a typical length less than five to ten times its diameter.

The inner diameter of distal joint portions 72 and 74 is larger than the outer diameter of distal joint portions 52 and 62 to allow distal joint portions 52 and 62 to be disposed within member 48. Since the members 46, 48, 50 are generally formed without machining, e.g. from purchased tubing or swaged tubing, each member can have a considerable range of distal joint portion diameters. Given this range of diameters the gap between a complementary set of members 46, 48 and 48, 50 can be in the range of about 0.001 inches to about 0.05 inches. In other embodiments the connector 48 is sized to fit within distal joint portions 52, 62.

To prepare a high pressure connection complementary members 46, 48 are provided. The mating surfaces 54, 78 should be clean and free of contamination. Abrasion of one or both mating surfaces may be advantageous. A primer composition is optionally applied to one mating surface 54 or 78 of one distal joint portion 46, 48 respectively. A curable composition is applied to a mating surface, typically of the other of the distal joint portion. The smaller diameter distal joint portion is slidingly disposed within the larger diameter distal joint portion. Some rotation of the distal joint portions may be beneficial to distribute the primer composition and curable composition around the entirety of the mating surfaces but is not required. The members 46, 48 are held in position for less than about 30 seconds, advantageously less than about 15 seconds and desirably less than about 15 seconds while exposed to conditions appropriate to at least partially cure the composition to allow the curable composition to maintain the second tubular member distal joint portion within the first tubular member distal joint portion. The composition may be further cured for a short time thereby forming the high pressure connection between the ends 58, 80 of the distal joint portions 52, 72. Typical cure times will be less than 60 minutes and advantageously less than 30 minutes before the connection can be pressurized for use. Distal joint portions 62 and 74 are processed in the same manner to form a second high pressure connection between the ends 88, 68 of distal joint portions 74, 62. The high pressure connection will maintain pressure greater than about 1200 pounds per square inch and advantageously greater than about 1500 pounds per square inch and more advantageously greater than about 2000 pounds per square inch after fully curing. Plastic deformation in the material of any distal joint portion after disposition of the smaller diameter distal joint portions within the larger diameter distal joint portions is advantageously avoided. The connector may be straight as shown in FIG. 3 or otherwise shaped such as a “U” shaped return bend, exemplified in FIG. 4, useful to fluidly connect condenser tubes.

The connector distal portions may have a smaller diameter than the corresponding tubular member distal portions so that the connector distal portions are disposed within the tubular member distal portions. Similarly, while the method is described with reference to the tubular connectors most often used, connectors of other shapes are possible.

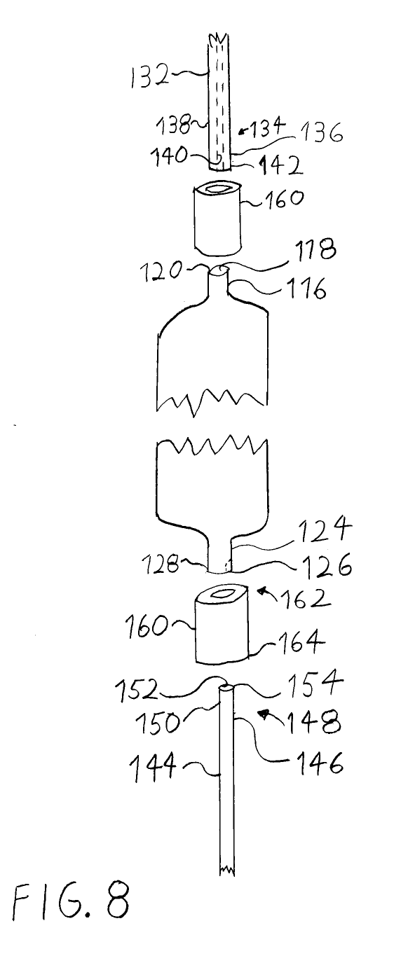

With reference to FIG. 7, the filter dryer unit 100 comprises an elongated tubular shell 102 with distal joint portions 104, 106 at each end 108, 110 respectively and optionally one or more fluid connections 114 extending from the side. The filter dryer unit is fluidly connected to the refrigeration system so that refrigerant flows therethrough, allowing filtering and/or drying of the refrigerant. In one embodiment shown in FIG. 1 the filter dryer unit is also metering device 14, with refrigerant flowing into end 108 and through elongated shell 102. Refrigerant is metered through capillary tube 18 connected to end 110 to the evaporator 16. Charge connection 20 provides an access point through which refrigerant can be added to the system. In other embodiments the filter dryer unit is connected elsewhere in the refrigeration system so that refrigerant flows therethrough, allowing filtering and/or drying of the refrigerant.

With reference to FIG. 8, distal joint portion 104 includes a substantially uniform cylindrical outer surface 116 free from threads having an outer diameter, a substantially uniform cylindrical inner surface 118 free from threads having an inner diameter and a circumferential end 120 connecting the outer 116 and inner 118 surfaces. Distal joint portion 106 includes a substantially uniform cylindrical outer surface 124 free from threads having an outer diameter, a substantially uniform cylindrical inner surface 126 free from threads having an inner diameter and a circumferential end 128 connecting the outer 124 and inner 126 surfaces.

Tubular members 132, 144 are part of the refrigeration system tubing used to carry refrigerant. Each tubular member 132, 144 is fluidly connected to one of the distal joint portions 104 and 106 of the filter dryer unit 100. Tubular member 132 has a distal joint portion 134 at one end 136. End 136 includes an outer surface 138 free from threads having an outer diameter, an inner surface 140 free from threads having an inner diameter and a circumferential end 142 connecting the outer 138 and inner 140 surfaces. Tubular member 144 is shown as a capillary tube variation with a diameter much smaller than tubular member 132. Tubular member 144 has a distal joint portion 146 at one end 148. End 148 includes an outer surface 150 free from threads having an outer diameter, an inner surface 152 free from threads having an inner diameter and a circumferential end 154 connecting the outer 150 and inner 152 surfaces.

With reference to FIG. 9, coupling 160 is generally tubular with two opposing ends 162, 164 and a bore 166 therethrough. End 162 includes an outer surface 168 free from threads having an outer diameter, an inner surface 172 free from threads that defines one portion of the bore 174 at end 162 and a circumferential end 176 connecting the outer 168 and inner 172 surfaces. End 164 includes an outer surface 178 free from threads having an outer diameter, an inner surface 182 free from threads that defines an opposing portion of the bore 184 at end 164 and a circumferential end 186 connecting the 178 and 182 surfaces.

Coupling bore portion 174 has an internal diameter that is sized to accommodate one filter dryer unit distal joint portion 104, 106 therein. Coupling bore portion 184 has an internal diameter that is sized to accommodate one tubular member unit distal joint portion 134, 146 therein. Since the members are generally formed without machining, e.g. from purchased tubing, swaged tubing, stamped or deep drawn parts, each member can have a considerable range of internal and external diameters. Given this range of diameters the gap between a complementary set of members (coupling bore portion 174, 184 and tubular member unit distal joint portion 134, 146) can be in the range of about 0 inches to about 0.005 inches or more.

The coupling 160 longitudinal length is predetermined to provide a greater overlap of tubular member distal joint portions 134 and 146 within respective portion of the coupling bore 184 than can be provided by placing the same distal joint portion within an existing filter dryer unit distal joint portion 104, 106. Coupling lengths useful in refrigeration systems provide an overlap of about 0.1 inches to about 1.0 inches with the tubular member disposed within.

To prepare a high pressure connection for a filter dryer unit, the filter dryer unit 100, tubular members 132, 144 and respectively sized couplings 160 are provided. The respective mating surfaces (in one variation distal joint portion outer surface 116 and coupling bore portion 174; coupling bore portion 184 and distal joint outer surface 138; distal joint portion outer surface 124 and coupling bore portion 174; and coupling bore portion 184 and distal joint outer surface 150) should be clean and free of contamination. Abrasion of one or both mating surfaces may be advantageous. A curable composition is applied to one or more mating surfaces. A primer composition is optionally applied to one mating surface, typically a mating surface to which curable composition has not been applied. The smaller diameter mating surface is slidingly disposed within the larger diameter mating surface. Some rotation of the mating surface may be beneficial to distribute the compositions around the entirety of the mating surfaces but is not required. The assembled coupling and distal joint portions are held in position for less than about 30 seconds, advantageously less than about 15 seconds while exposed to conditions appropriate to at least partially cure the composition to allow the cured composition to maintain the distal joint portions within the coupling bore portion. The composition may be further cured for a short time thereby forming the high pressure connection between the end of distal joint portion 104, coupling 160 and distal joint portion 134 or between the end of distal joint portion 106, coupling 160 and distal joint portion 146. Typical cure times will be less than 60 minutes and advantageously less than 30 minutes before the connection can be pressurized for use. The high pressure connection will maintain pressure greater than about 1200 pounds per square inch and advantageously greater than about 1500 pounds per square inch and more advantageously greater than about 2000 pounds per square inch under typical refrigeration use conditions after fully curing. Plastic deformation in the material of any mating surface after disposition of the smaller diameter portion within the larger diameter portion is advantageously avoided.

Surprisingly, use of a curable composition to bond a coupling 160 to filter dryer distal joint portions 104, 106 and tube 132, 144 within coupling bore 184 results in a surprisingly robust high pressure connection suitable for use in a refrigeration system.

In some variations (not shown) the tubular member 132, 144 distal portions may have a larger diameter than the corresponding coupling end exterior diameter so that the tubular member distal portion is disposed over the coupling end. In some variations (not shown) the coupling end exterior diameter may have a smaller diameter than the corresponding filter dryer unit distal joint portion interior diameter so that the coupling end is disposed within the distal joint portion. Similarly, while the method is described with reference to the tubular connectors most often used, connectors of other shapes are possible.

The radically curable composition can be an anaerobically curable composition. Radically curable compositions typically comprise one or more functional (meth)acrylate components, one or more cure-inducing components and one or more additives. Additives can include free radical inhibitors, stabilizers, viscosity modifiers, rheology modifiers, polymeric support matrix, activators, reactive carriers, thickeners, plasticizers, pigments, dyes, diluents, solvents and fillers. The components are chosen to provide properties in the uncured composition and cured reaction products desirable for an application. The curable composition can be a one part system where all components are present in a single, commercially storage stable, composition that is ready to use as received. Alternatively, the curable composition can be a two part composition where each part includes only a portion of the components of the total composition. The parts are commercially storage stable when separated but begin to rapidly cure when mixed and the parts must be mixed slightly before application.

The functional (meth)acrylate component can comprise one or more (meth)acrylate materials and will form the basis of the radically curable composition. That is, the curable composition may be comprised of greater than about 60% by weight of functional (meth)acrylate component, such as about greater than about 65% by weight, desirably within the range of about 70% to about 75% by weight. If both mono and polyfunctional (meth)acrylate materials are present in the curable composition the monofunctional (meth)acrylate material is advantageously present in an amount in the range of about 1% to about 30% by weight of the total composition and more advantageously in the range of about 10% to about 25% by weight of the total composition.

At least a portion of the (meth)acrylate component can be a mono-functional (meth)acrylate material. Thus, the (meth)acrylate materials that may be used in the curable composition include a wide variety of materials represented by H₂C=C(G)C(O)OR, where G may be hydrogen, halogen or alkyl of 1 to about 4 carbon atoms, and R may be selected from alkyl, cycloalkyl, alkenyl, cycloalkenyl, alkaryl, aralkyl, heterocyclic, hydroxyalkyl, or aryl groups of 1 to about 16 carbon atoms. As used herein halo or halogen includes fluorine, chlorine, bromine and iodine.

Other desirable polymerizable (meth)acrylate materials useful in the curable composition include those which fall within the structure:

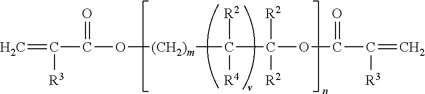

where each R² is independently selected from hydrogen, alkyl of 1 to about 4 carbon atoms, hydroxyalkyl of 1 to about 4 carbon atoms or

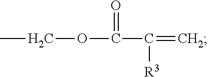

each R³ is independently selected from hydrogen, halogen, and alkyl of 1 to about 4 carbon atoms and C₁₋₈ mono- or bicycloalkyl, a 3 to 8 membered heterocyclic radical with a maximum of 2 oxygen atoms in the ring;

each R⁴ is independently selected from hydrogen, hydroxy and

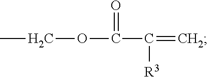

each m is independently an integer equal to at least 1, e.g., from 1 to about 8 or higher, for instance from 1 to about 4;

each n is independently an integer equal to at least 1, e.g., 1 to about 20 or more; and v is 0 or 1.

Other desirable (meth)acrylate materials are those selected from acrylate functionalized urethanes within the general structure:

(CH₂=CR⁵.CO.O.R⁶.O.CO.NH)₂R⁷

where each R⁵ is independently selected from H, CH₃, C₂H₅ or halogen, such as Cl; each R⁶ is independently selected from (i) a C₁₋₈ hydroxyalkylene or aminoalkylene group, (ii) a C₁₋₆ alklamino-C₁₋₈ alkylene, a hydroxyphenylene, aminophenylene, hydroxynaphthalene or amino-naphthalene optionally substituted by a C₁₋₃ alkyl, C₁-₃ alkylamino or di-C₁₋₃ alkylamino group; and each R⁷ is independently selected from C₂₋₂₀ alkylene, alkenylene or cycloalkylene, C₆₋₄₀ arylene, alkarylene, aralkarylene, alkyloxyalkylene or aryloxyarylene optionally substituted by 1-4 halogen atoms or by 1-3 amino or mono- or di-C₁₋₃ alkylamino or C₁₋₃ alkoxy groups; or acrylates within the general structure:

(CH₂=CR⁵.CO.O.R⁶.O.CO.NH.R⁷.NH.CO.X—)ₙR⁸

where R⁵, R⁶, and R⁷ are as given above; R⁸ is a non-functional residue of a polyamine or a polhydric alcohol having at least n primary or secondary amino or hydroxy groups respectively; X is O or NR⁹, where R⁹ is H or a C₁₋₇ alkyl group; and n is an integer from 2 to 20.

Among the specific monofunctional polymerizable acrylate ester materials particularly desirable in the (meth)acrylate component, and which correspond to certain of the structures above, are hydroxypropyl methacrylate, 2-hydroxyethyl methacrylate, methyl methacrylate, tetrahydrofurfuryl methacrylate, cyclohexyl methacrylate, 2-aminopropyl methacrylate and the corresponding acrylates.

Specific polyfunctional (meth)acrylate materials which are desirable in the (meth)acrylate component include polyethylene glycol dimethacrylate and dipropylene glycol dimethacrylate.

Other desirable polymerizable acrylate ester monomers useful in the (meth)acrylate component are selected from the class consisting of the acrylate, methacrylate and glycidyl methacrylate esters of bisphenol A. Particularly desirable among all of the free-radical polymerizable monomers mentioned are ethoxylated bisphenol-A-dimethacrylate (“EBIPMA”).

Mixtures or copolymers of any of the above-mentioned free-radical polymerizable materials can be employed.

Polymerizable vinyl monomers may also be optionally incorporated in the (meth)acrylate component and are represented by the general structure:

R¹⁰-CH=CH-R¹⁰

where each R¹⁰ is independently selected from alkyl, aryl, alkaryl, aralkyl, alkoxy, alkylene, aryloxy, aryloxyalky, alkoxyaryl, aralkylene, OOC-R¹, where R¹ is defined above, can also be effectively employed in the instant composition.

Copolymers or mixtures of monomers disclosed herein with other compatible monomers are also contemplated.

Among the polymerizable polyacrylate esters utilized in the (meth)acrylate component include those which are exemplified but not restricted to the following materials: di-, tri-, and tetra-ethylene glycol dimethacrylate, dipropylene glycol dimethacrylate, polyethylene glycol dimethacrylate, di(pentamethylene glycol) dimethacrylate, tetraethylene glycol diacrylate, tetraethylene glycol di(chloroacrylate), diglycerol diacrylate, diglycerol tetramethacrylate, tetramethylene dimethacrylate, ethylene dimethacrylate, neopentyl glycol diacrylate and trimethylol propane triacrylate. The foregoing materials need not be in the pure state, but may comprise commercial grades in which inhibitors or stabilizers, such as polyhydric phenols, quinones, and the like are included. These inhibitors function as free radical inhibitors to prevent premature polymerization. It is also within the scope of this disclosure to obtain modified characteristics for the cured composition by utilization of one or more monomers either from those listed above or additional additives such as unsaturated monomers, including unsaturated hydrocarbons and unsaturated esters.

Some specific (meth)acrylates particularly useful in the curable composition include polyethylene glycol di(meth)acrylates, bisphenol-A di(meth)acrylates, such as ethoxylated bisphenol-A (meth)acrylate (“EBIPMA”) and tetrahydrofurane (meth)acrylates and di(meth)acrylates, isobornyl acrylate, hydroxypropyl (meth)acrylate, and hexanediol di(meth)acrylate. Of course, combinations of these (meth)acrylates may also be used.

The curable composition is rendered curable by including a cure-inducing component that uses a free radical cure mechanism and advantageously uses an anaerobic cure mechanism.

The radical cure-inducing component can also be a heat-cure initiator or initiator system comprising a redox polymerization initiator (i.e., an ingredient or a combination of ingredients which at the desired elevated temperature conditions, e.g., from about 90° C. to about 150° C. (about 194° F. to about 302° F.) produces an oxidation-reduction reaction, resulting in the production of free radicals). Suitable initiators may include peroxy materials, e.g., peroxides, hydroperoxides, and peresters, which under appropriate elevated temperature conditions decompose to form peroxy free radicals which are initiatingly effective for the polymerization of the heat-curable compositions. The peroxy materials may be employed in the radical cure-inducing component in concentrations on the order of about 0.1% to about 10%.

Another useful class of heat-curing initiators comprises azonitrile compounds which yield free radicals when decomposed by heat. Heat is applied to the curable composition and the resulting free radicals initiate polymerization of the curable composition.

For example, azonitrile may be a compound of the formula:

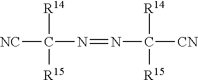

where each R¹⁴ is independently selected from a methyl, ethyl, n-propyl, iso-propyl, iso-butyl or n-pentyl radical, and each R¹⁵ is independently selected from a methyl, ethyl, n-propyl, iso-propyl, cyclopropyl, carboxy-n-propyl, iso-butyl, cyclobutyl, n-pentyl, neo-pentyl, cyclopentyl, cyclohexyl, phenyl, benzyl, p-chlorobenzyl, or p-nitrobenzyl radical or R¹⁴ and R¹⁵, taken together with the carbon atom to which they are attached, represent

a radical of the formula

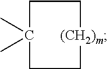

where m is an integer from 3 to 9, or the radical, or

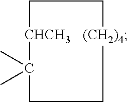

Compounds of the above formula are more fully described in U.S. Pat. No. 4,416,921, the disclosure of which is incorporated herein by reference.

Azonitrile initiators of the above-described formula are readily commercially available, e.g., the initiators which are commercially available under the trademark VAZO from E. I. DuPont de Nemours and Company, Inc., Wilmington, Del., including VAZO 52 (R¹⁴ is methyl, R¹⁵ is isobutyl), VAZO 64 (R¹⁴ is methyl, R¹⁵ is methyl), and VAZO 67 (R¹⁴ is methyl, R¹⁵ is ethyl), all such R¹⁴ and R¹⁵ constituents being identified with reference to the above-described azonitrile general formula. A desirable azonitrile initiator is 2,2′-azobis(iso-butyronitrile) or AZBN.

The azonitrile may be employed in the cure-inducing component in concentrations on the order of about 500 to about 10,000 parts per million (ppm) by weight, desirably about 1,000 to about 5,000 ppm.

The cure-inducing component can be an anaerobic cure-inducing component. Using an anaerobic cure-inducing component allows curing of the curable composition to begin in the absence of air.

Examples of anaerobic cure-inducing components include amines (including amine oxides, sulfonamides and triazines). Other cure-inducing components include saccharin, toluidenes, such as N,N-diethyl-p-toluidene and N,N-dimethyl-o-toluidene, acetyl phenylhydrazine, and maleic acid. Of course, other materials known to induce anaerobic cure may also be included or substituted therefore. See e.g. U.S. Pat. Nos. 3,218,305 (Krieble), No. 4,180,640 (Melody), No. 4,287,330 (Rich) and No. 4,321,349 (Rich), the disclosures of which are incorporated herein by reference. Quinones, such as napthoquinone and anthraquinone, may also be included to scavenge free radicals.

The anaerobic cure-inducing component should be used in an amount up to about 10% by weight of the total curable composition, such as in the range of about 6% to about 8% by weight of the total curable composition.

The curable composition may optionally include a fluorescent dye to allow the user to determine composition presence and location on the high pressure connection.

The curable composition in the uncured state can have a range of viscosities, for example about 200 cps to about 4,000 cps, depending on application. Lower viscosities are useful in applications where a more fluid composition is desired while higher viscosities are useful in applications where less flow is desired. In addition, the composition in the cured state should be flexible/tough so as to absorb vibration that is present in a refrigeration system. The composition must also have good adhesive properties to maintain connection integrity under internal pressures more then 1200 pounds per square inch.

In one embodiment a primer composition can be used with the curable composition. The primer composition includes a polymerizable (meth)acrylate monomer and a polymerization initiator for the monomer

In another embodiment the curable composition includes a self-supporting combination of a polymerizable (meth)acrylate monomer; a polymerization initiator; and optionally, a polymeric matrix miscible with the (meth)acrylate and the initiator, and optionally, a polymeric matrix miscible or otherwise compatible with the monomer. The matrix material may be present in an amount sufficient to render the curable composition self supporting, i.e. non-flowable at temperatures of at least about 70° F. (21° C.), and up to about 160° F. (71° C.). The polymeric matrix and polymerizable component readily form a stable mixture or combination without phase separation of component parts. Polymeric matrix materials are known and include, for example, urea-urethanes, hydroxy or amine modified aliphatic hydrocarbons (such as castor oil-based rheological additives), liquid polyester-amide-based rheological additives, polyacrylamides, polyimides, polyhydroxyalkylacrylates, and combinations thereof.

The curable composition and/or primer composition can include an activator. Some useful activators are disclosed in U.S. Pat. No. 7,408,010 (Patel et al.), the contents of which are incorporated herein by reference. In some embodiments the curable composition and or primer composition include, a reactive carrier, a polymeric matrix, or a reactive carrier and a polymeric matrix.

The activator may differ depending on the nature and identity of the curable composition. In the case of anaerobically curable compositions the activator can comprise transition metal containing compounds, peroxy compounds, free radical promoters and the like as desired for the chosen anaerobically curable composition.

Useful activators comprising a transition metal-containing compound include those containing copper. The transition metal-containing compound may be selected from a list of materials, including among others copper-containing compounds or complexes, such as copper naphthenate, copper carbonate and cupric acetylacetone. Other desirable transition metal-containing compounds or complexes include those having iron or cobalt.

Useful activators comprising peroxy compounds include the hydroperoxy polymerization initiators and most preferably the organic hydroperoxide initiators having the formula ROOH, where R generally is a hydrocarbon radical containing up to about 18 carbons, desirably an alkyl, aryl or aralkyl radical containing up to about 12 carbon atoms. Typical examples of such hydroperoxides include cumene hydroperoxide, methylethylketone hydroperoxide as well as hydroperoxides formed by the oxygenation of various other hydrocarbons such as methylbutene, cetane and cyclohexane. Other peroxy initiators such as hydrogen peroxide or materials such as organic peroxides or peresters which hydrolyze or decompose to form hydroperoxides may also be employed.

The peroxy compounds commonly employed comprise less than about 20% by weight of the total composition. Desirably, however, they are employed in lower levels such as about 0.1% to about 10% by weight of the total composition.

Useful activators comprising free radical promoters include the heat-cure initiator or initiator systems comprising a redox polymerization initiator discussed above.

It is advantageous that the carrier used in the composition and especially the primer composition is reactive, i.e. the carrier will participate in the curing reaction of the curable composition. Useful reactive carriers include (meth)acrylate monomers and mixtures, advantageously mono-functional (meth)acrylate monomers and mixtures, for example hydroxyethyl (meth)acrylate and hydroxypropyl (meth)acrylate. The carrier can comprise about 50% or more of the total weight of the primer composition.

Known primer compositions are typically formulated to have a low viscosity. A low viscosity is generally considered advantageous for many applications as it lets these materials flow into small gaps or openings by capillary action. However, low viscosity materials are less desirable in applications such as high pressure connections wherein the mating members may have large gaps. For large gap high pressure connections the primer compositions is advantageously non-flowable, i.e., capable of existing in a self-supporting mass without migrating at temperatures of up to 160° F. (71° C.). Use of non-flowable compositions is surprisingly effective in bridging the gap between complementary refrigeration members to help provide a high pressure connection that can withstand more than 1200 pounds per square inch of internal pressure. Desirably the composition will be non-flowable at temperatures at working temperatures, for example temperatures in the range of about 60° F. (21° C.) to about 160° F. (71° C.).

Composition rheology properties, i.e., composition flowability, can be modified by adding polymeric matrix materials. The amount of polymeric matrix in the composition will vary from about 0% to about 30% or more. If flowability of the composition is desired the composition can comprise none or very little polymeric matrix. Addition of a diluent or solvent can also enhance composition flowability. As the amount of polymeric matrix in the composition is increased it becomes less flowable. The amount of polymeric matrix is only limited on the upper end by the strength and stiffness required in the final product. Of course, this is be balanced with the desired strength of the adhesive or the particular sealing characteristics desired. Addition of polymeric matrix in amounts of about 2.5% to about 20%, for instance about 5% to about 15%, such as about 7% to about 10%, by weight of the total composition can provide a composition having non-flowability characteristics with minimal undesirable effects, such as loss of substantial tensile properties or sealing characteristics.

The polymeric matrix includes an organic material which generally has a melting point or softening point range in the range of about 200° F. (93° C.) to about 500° F. (260° C.), more desirably greater than 250° F. (121° C.) to about 500° F. (260° C.). Polymeric materials may be selected from urea-urethanes, hydroxy or amine modified aliphatic hydrocarbons (such as castor oil-based rheological additives), liquid polyester-amide-based rheological additives and combinations thereof. In addition, the polymeric matrix may further include polyamides, polyacrylamides, polyimides, and polyhydroxyalkylacrylates.

Of particular utility are polyamide materials having a melting point of about 260° F. (127° C.). One such polyamide is commercially available as a non-reactive free flowing powder under the tradename DISPARLON 6200, from King Industries Specialties Company, Norwalk, Conn. Other polyamides include DISPARLON 6100 and 6500. The recommended use in accordance with commercially available data sheets for DISPARLON 6200 is for epoxy adhesive and potting compounds in amounts of about 0.5% to about 3% by weight; the recommended use in accordance with commercially available data sheets for DISPARLON 6500 is for epoxy adhesive and potting compounds in amounts of about 0.5% to about 3% by weight.

The polyamide materials of the primer composition desirably have a particle size less than about 15 microns, although other particle sizes are useful. As previously mentioned, the melting or softening point of the polymeric matrix materials ranges from about 200° F. (93° C.) to about 500° F. (260° C.). In a particularly desirable embodiment, a polyamide having a melting point of about 250° F.-270° F. (121° C.-132° C.) and more desirably about 260° F. (127° C.) is employed.

Another rheology additive is encompassed by a urea-urethane including a combination of an alkali metal cation and the reaction product of (a) a polyfunctional isocyanate and an hydroxy and an amine; or (b) a phosgene or phosgene derivative, and a compound having 3 to 7 polyethylene ether units terminated at one end with an ether group and at the other end with a reactive functional group selected from an amine, an amide, a thiol or an alcohol; or (c) a monohydroxy compound, a diisocyanate and a polyamine. When the reaction product described in (c) is employed it is generally formed by first reacting a monohydroxy compound with a diisocyanate to form a mono-isocyanate adduct, and subsequently reacting the mono-isocyanate reaction product with a polyamine in the presence of an alkali metal salt and an aprotic solvent, as described in U.S. Pat. No. 4,314,924, the disclosure of which is incorporated herein by reference.

Useful isocyanates for forming the reaction product(s) of the additive include polyisocyanates such as phenyl diisocyanate, toluene diisocyanate, 4,4′-diphenyl diisocyanate, 4,4′-diphenylene methane diisocyanate, dianisidine diisocyanate, 1,5-naphthalene diisocyanate, 4,4′-diphenyl ether diisocyanate, p-phenylene diisocyanate, 4,4′-dicyclo-hexylmethane diisocyanate, 1,3-bis-(isocyanatomethyl) cyclohexane, cyclohexylene diisocyanate, tetrachlorophenylene diisocyanate, 2,6-diethyl-p-phenylenediisocyanate, and 3,5-diethyl-4,4′-diisocyanatodiphenylmethane. Still other polyisocyanates that may be used are polyisocyanates obtained by reacting polyamines containing terminal, primary and secondary amine groups or polyhydric alcohols, for example, the alkane, cycloalkane, alkene and cycloalkane polyols such as glycerol, ethylene glycol, bisphenol-A, 4,4′-dihydroxy-phenyldimethylmethane-substituted bisphenol-A, and the like, with an excess of any of the above-described isocyanates.

Useful alcohols for reacting with the polyisocyanates also include polyethyl glycol ethers having 3-7 ethylene oxide repeating units and one end terminated with an ether or an ester, polyether alcohols, polyester alcohols, as well as alcohols based on polybutadiene. The specific type of alcohol chosen and the molecular weight range can be varied to achieve the desired effect. Generally, monohydroxy compounds, straight or branched chain aliphatic or cyclic primary or secondary alcohols containing C₅₋₂₅, and alkoxylated derivatives of these monohydroxy compounds are useful.

Phosgene and phosgene derivatives, such as bischloroformates, may be used to make the reaction product of the additive (c). These compounds are reacted with a nitrogen-containing compound, such as an amine, an amide or a thiol to form the adduct. Phosgenes and phosgene derivatives may also be reacted with an alcohol to form the reaction product.

The alkali metal cations are usually provided in the form of a halide salt. For example, sodium, potassium and lithium halide salts are useful. In particular, sodium chloride, sodium iodide, sodium bromide, potassium chloride, potassium iodide, potassium bromide, lithium chloride, lithium iodide, lithium bromide and combinations thereof may be employed.

The reaction products of additive (c) are usually present in and added to the composition with an alkali metal salt, in a solvent carrier. The solvents are desirably polar aprotic solvents in which the reaction to form the reaction product was carried out. For example, N-methyl pyrrolidone, dimethylsulfoxide, hexamethylphosphoric acid triamide, N,N-dimethylformamide, N,N,N′,N′-tetramethylurea, N,N-dimethylacetamide, N-butylpyrrolidone, tetrahydrofuran and diethylether may be employed.

One particularly desirable additive is the combination of a lithium salt and a reaction product which is formed by reacting a monohydroxy compound with a diisocyanate compound to form a mono-isocyanate first adduct, which is subsequently reacted with a polyamine in the presence of lithium chloride and 1-methy-2-pyrrolidone to form a second adduct. A commercially available additive of this sort is sold by BYK USA Inc., Wallingford, Conn. under the tradename BYK 410. This commercially available additive is described by BYK product literature as being a urea urethane having a minor amount of lithium chloride present in a 1-methyl-2 pyrrolidone solvent.

Amines which can be reacted with phosgene or phosgene derivatives to make the reaction product include those which conform to the general formula R¹¹-NH₂, where R¹¹ is aliphatic or aromatic. Desirable aliphatic amines include polyethylene glycol ether amines. Desirable aromatic amines include those having polyethylene glycol ether substitution on the aromatic ring.

For example, commercially available amines sold under the tradename JEFFAMINE by Huntsman Corporation, Houston, TX may be employed. Examples include JEFFAMINE D-230, JEFFAMINE D-400, JEFFAMINE D-2000, JEFFAMINE T-403, JEFFAMINE ED-600, JEFFAMINE ED-900, JEFFAMINE ED-2001, JEFFAMINE EDR-148, JEFFAMINE XTJ-509, JEFFAMINE T-3000, JEFFAMINE T-5000, and combinations thereof.

The JEFFAMINE D series are diamine based products and may be represented by:

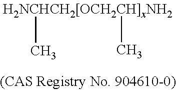

where x is about 2.6 (for JEFFAMINE D-230), 5.6 (for JEFFAMINE D-400) and 33.1 (for JEFFAMINE D-2000), respectively.

The JEFFAMINE T series are trifunctional amine products based on propylene oxide and may be represented by:

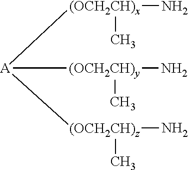

where x, y and z are each independently 1 to 40 and A is set forth below in Table 1.

TABLE 1

| | | |
|---|---|---|
| JEFFAMINE | Approx. | Mole |

| Product | Initiator (A) | Mol. Wt. | % |
|---|---|---|---|
| T-403 | Trimethylolpropane | 440 | 5-6 |
| T-3000 | Glycerin | 3,000 | 50 |
| T-5000 | Glycerin | 5,000 | 85 |

More specifically, the JEFFAMINE T-403 product is a trifunctional amine and may be represented by:

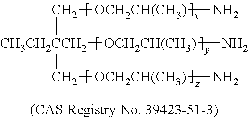

where x+y+z is 5.3.

The JEFFAMINE ED series are polyether diamine-based products and may be represented by:

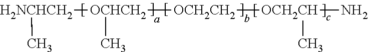

where a, b and c are set forth below in Table 2.

TABLE 2

| | | |
|---|---|---|
| JEFFAMINE | Approx. Value | Approx. |

| Product | b | a + c | Mol. Wt. |
|---|---|---|---|
| ED-600 | 8.5 | 2.5 | 600 |
| ED-900 | 15.5 | 2.5 | 900 |
| ED-2001 | 40.5 | 2.5 | 2,000 |

Amides useful for reacting with the phosgene or phosgene derivatives include those which correspond to the following formula:

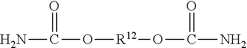

where R¹² may be an aliphatic or aromatic, substituted or unsubstituted, hydrocarbon or heterohydrocarbon, substituted or unsubstituted, having C₁₋₃₆.

Alcohols useful in forming the reaction product with the phosgene or phosgene derivatives include those described above.

Another polymeric matrix useful herein includes hydroxyl or amine modified aliphatic hydrocarbons and liquid polyester-amide based rheological additives. Hydroxy or amine modified aliphatic hydrocarbons include THIXCIN R, THIXCIN GR, THIXATROL ST and THIXATROL GST available from Rheox Inc., Hightstown, N.J. These modified aliphatic hydrocarbons are castor oil based materials. The hydroxyl modified aliphatic hydrocarbons are partially dehydrated castor oil or partially dehydrated glycerides of 12-hydrostearic acid. These hydrocarbons may be further modified with polyamides to form polyamides of hydroxyl stearic acid are described as being useful polyamides.

Liquid polyester-amide based rheological additives include THIXATROL TSR, THIXATROL SR and THIXATROL VF rheological additives available from Rheox Inc., Hightstown, N.J. These rheological additives are described to be reaction products polycarboxylic acids, polyamines, alkoxylated polyols and capping agents. Useful polycarboxylic acids include sebacic acid, poly(butadiene) dioic acids, dodecane dicarboxylic acid and the like. Suitable polyamines include diamine alkyls. Capping agents are described as being monocarboxylic acids having aliphatic unsaturation.

The composition can comprise a toughening agent component that decreases brittleness and increases toughness of the cured reaction products of the composition as compared to cured reaction products of the same curable composition without the toughening agent component.

The amount of toughening agent component can be varied to suit particular applications. The lower level will be that level which provides a desired decrease in brittleness and increase in toughness of the cured reaction products of the curable composition. The upper level of toughening agent component will be set by considerations of cost and by increase in the viscosity of the primer composition. The concentration range of toughening agent component can be from about 0.5% to about 50% or more by weight of primer composition, for example from about 1% to about 40 percent by weight of primer composition, and advantageously from about 5% to about 30% by weight of primer composition.

Examples of some useful toughening agents include elastomeric rubbers; elastomeric polymers; liquid elastomers; polyesters; acrylic rubbers; butadiene/acrylonitrile rubber; Buna rubber; polyisobutylene; polyisoprene; natural rubber; synthetic rubber such as styrene/butadiene rubber (SBR); polyurethane polymers; ethylene-vinyl acetate polymers; fluorinated rubbers; isoprene-acrylonitrile polymers; chlorosulfonated polyethylenes; homopolymers of polyvinyl acetate; block copolymers; core-shell rubber particles, and mixtures thereof.

The form of the toughening agent will depend on the material chosen and can include particles, nanoparticles, core-shell particles having layers of different hardnesses, liquids, solutions and discrete phases.

Elastomeric toughening agents are described in U.S. Pat. No. 3,496,250 (Czerwinski); U.S. Pat. No. 3,655,825 (Souder et al); U.S. Pat. No. 3,668,274 (Owens et al); U.S. Pat. No. 3,864,426 (Salensky); U.S. Pat. No. 4,440,910 (O'Connor) and U.S. Pat. No. 5,932,638 (Righettini et al), the contents of each of which is herein incorporated by reference. Useful commercially available toughening agents include those marketed under the tradename HYCAR, commercially available from The Lubrizol Corporation; VAMAC ethylene acrylic elastomers such as VAMAC G, VAMAC VCS, VAMAC VMX and VAMAC VCD, all commercially available from DuPont; BLENDEX BTA III F, ACRYLOID KM 680, ACRYLOID KM 653, ACRYLOID KM 611, and ACRYLOID KM 330 copolymers, all commercially available from Rohm and Haas Company, BLENDEX 101 copolymer, commercially available from Borg-Warner Corp., METABLEN C 223 copolymer, commercially available from M & T Chemicals, Inc., and KANE Ace-B copolymer, commercially available from Kaneka USA.

Commercially available examples of block copolymer toughening agents include EUROPRENE SOL T 193A available from Enichem Elastomers Americas, Inc. and Kraton SBR block copolymer available from Kraton Polymers LLC, Houston, Tex. Polyurethane polymer toughening agents can include, for example, materials such as the MILLATHANE polymers available from TSE Industries.

Liquid elastomer toughening agents are described in U.S. Pat. No. 4,223,115 (Zalucha et al); U.S. Pat. No. 4,452,944 (Dawdy); U.S. Pat. No. 4,769,419 (Dawdy); U.S. Pat. No. 5,641,834 (Abbey et al), U.S. Pat. No. 5,710,235 (Abbey et al) and U.S. Pat. No. 5,932,638 (Righettini et al), the content of each of which is herein incorporated by reference.

Other agents common to the adhesive art, for example, thickeners, plasticizers, pigments, dyes, diluents, solvents and fillers, and can be employed in the compositions in any reasonable manner to produce desired functional characteristics, providing they do not significantly interfere with the ability of the primer composition to initiate polymerization of the curable composition or interfere with providing a high pressure connection. If present, inert fillers may be used in relatively high amounts as compared to conventional threadlocking systems.

Exemplary Adhesive Composition

An exemplary two part adhesive composition is listed below. Part A can comprise:

| | wt. % |
|---|---|
| Part A | |
| monofunctional methacrylate compound | 30-60 |
| methacrylate functionalized urethane | 10-30 |
| toughening agent | 5-30 |
| 2,4,6-Triallyloxy-1,3,5-triazine | 5-10 |
| triethylene glycol dimethacrylate | 1-5 |
| propylene glycol monomethacrylate | 1-5 |
| methacrylic acid | 1-5 |
| activator | 0.1-1.0 |
| anaerobic cure inducing component | 0-2 |
| urea rheology additive | 0-5 |
| organic thickener | 0-5 |
| Part B can comprise: | |
| Part B | |
| toughening agent | 50-90 |
| methacrylic acid | 10-30 |
| monofunctional methacrylate compound | 1-20 |
| polyfunctional methacrylate | 1-5 |
| 1-acetyl-2-phenylhydrazine | 0.1-1 |
| organic thickener | 0-12 |
| free radical scavengers | 0-5 |
| silica, fumed | 0-5 |
| activator | 0-3 |

Preparation of the compositions can be achieved by simple admixture of the preselected materials. If present, no premelting of the polymeric matrix is necessary and the polymeric matrix can be in either the liquid or solid form prior to incorporation thereof. Although it is not necessary to heat the primer composition prior to incorporation of the polymeric matrix, as a practical matter it is desirable to slightly elevate the temperature to within the range of about 40-60° C., such as about 50° C. (122° F.), while using a mixer or dispenser machine to incorporate the polymeric matrix. Mixing is performed for a time sufficient to incorporate the matrix material into the primer composition, which can vary depending on the batch size. Generally, only seconds or minutes are required to achieve the desired blending in of the matrix material. The composition will render itself non-flowable in approximately 2 to about 100 hours at room temperature depending on the nature and relative amounts the primer composition components. This is due to the unique nature of the polymeric matrix, which is designed to be swellable and effectively form a branched matrix in situ. While not wishing to be bound by any particular hypothesis, it is believed that the polymeric matrix particles retain their particulate nature, yet imbibe large amounts of the composition materials. In doing so, they lend the non-flowable characteristics to the composition, yet apply smoothly to a surface by virtue of its particulate nature. It appears that a portion of the matrix particle is solubilized which permits the imbibing, and a portion remains unsolubilized which allows for retention of its particulate form.

The following examples are included for purposes of illustration so that the disclosure may be more readily understood and are in no way intended to limit the scope of the disclosure unless otherwise specifically indicated.

### EXAMPLES

Adhesive

Each test specimen was prepared using the same two part, anaerobic curing adhesive with the two parts falling within the exemplary composition.

Each of Parts A and B was separately loaded into a dual tube cartridge. The dual tube cartridge was placed in a manual dispenser and a static mix nozzle was placed over the discharge ports of the dual tube cartridge. Approximately 2 to 3 grams of adhesive was forced through the static mix nozzle and mixed and dispensed onto a test part.

Shear Strength Test:

A bonded and cured assembly was provided. The ends of the capillary tube and eliminator tube were flattened in a vise. The flattened ends were secured in the grips of an Instron Mechanical Properties Tester. The test specimen was pulled in tension at a crosshead speed of 0.2 inches per minute. The peak load obtained and the failure mode were recorded.

The failed test specimen was resecured in the grips using the non-failed tube and the filter dryer shell distal portion corresponding to the failed tube. The test specimen was pulled in tension at a crosshead speed of 0.2 inches per minute. The peak load obtained and the failure mode were recorded.

The test was repeated as necessary.

Leak Test:

A bonded and cured assembly was provided. The end of the capillary tube was sealed. The charge connection, if present, was sealed. The eliminator tube was fluidly connected to an inert (nitrogen, helium) gas source. Gas was introduced into the test specimen to a pressure of 450 psi gauge. All joints were observed for air bubbles using a soap solution. A bonded joint that held 450 psig pressure for 10 seconds with no leakage is considered passing. Any joint leakage under 450 psig at 10 seconds or less was considered a failure.

Burst Test:

A bonded and cured assembly was provided. The end of the capillary tube was sealed. The charge connection, if present, was sealed. The eliminator tube was fluidly connected to a hydraulic (oil) pressure source. Pressurized hydraulic fluid was introduced into the test specimen to a pressure of 4000 psi gauge. Peak pressure to failure and failure mode were recorded. A specimen withstanding a peak pressure of 1,800 psig was considered passing, although it is preferred that the test specimen withstand a pressure over 2,000 psig.

Thermal Cycle Test:

The bonded assembly was allowed to room temperature cure for 24 hours. The cured assembly was exposed to the following temperature cycle: hold at −18° C. for 1 hour, heat from −18° C. to 149° C. over 1 hour, hold at 149° C. for 1 hour, cool from 149° C. to −18° C. over 1 hour for 250 cycles. After completion of 250 cycles the bonded assembly was allowed to come to room temperature. The room temperature bonded assembly was secured in a tensile tester and placed under tension and the force required to break the bond was noted. Typically a minimum of three assemblies were tested.

### Example 1

Sample Preparation

The adhesive used was a mixture of Parts A and B. A plurality of filter dryer shells; capillary tubes; eliminator tubes and couplings were provided. All parts were copper or copper alloy. Capillary tubes had a nominal outside diameter of about 0.08 inches and a length of about three inches. Eliminator tubes had a nominal outside diameter of about 0.2 inches and a length of about three inches. All surfaces to be bonded were cleaned with isopropyl alcohol and allowed to air dry.

Each capillary tube was marked one inch from an end.

The capillary tube was inserted into a coupling so that the larger diameter bore of the coupling faced the free end of the one inch capillary tube portion but was more than one inch from that fee end.

Adhesive was dispensed into the larger diameter bore of the coupling and onto the capillary tube along the measured one inch length. Approximately 0.03 grams to 0.05 grams of adhesive was used for each capillary joint.

The capillary tube was inserted into the filter dryer shell up to the one inch mark. The coupling was pressed over the distal end of the filter dryer shell, to provide a structure comprising an inner capillary tube, a layer of adhesive, the filter dryer distal portion, a layer of adhesive and the coupling.

For test specimens not using a capillary tube coupling, adhesive was dispensed onto the capillary tube along the measured one inch length. Approximately 0.005 grams to 0.01 grams of adhesive was used for each capillary joint. The capillary tube was inserted into the filter dryer shell up to the one inch mark to provide a structure comprising an inner capillary tube, a layer of adhesive, and the filter dryer distal portion.

Adhesive was dispensed onto the eliminator tube along the final 0.3 inches. Approximately 0.02 grams of adhesive was used for each eliminator joint. No couplings were used with eliminator joints in this testing. The eliminator tube was inserted into the filter dryer shell up to the 0.3 inch length to provide a structure comprising an inner eliminator tube, a layer of adhesive, and the filter dryer distal portion.

Samples were allowed to cure for at least 48 hours under standard laboratory conditions before further testing. Results of testing on these samples is shown in the

Table below.

TABLE 1
Shear Strength

| | |
|---|---|
| conditions | No couplings on either tube. Samples gripped by capillary |
| | tube and eliminator tube. |

| | strength | |
|---|---|---|
| sample | (lbf) | failure mode |
| 1 | 91 | Capillary tube pulled free of shell. Adhesive failure. |
| 2 | 37 | Capillary tube pulled free of shell. Adhesive failure. |
| 3 | 102 | Capillary tube pulled free of shell. Adhesive failure. |

Table 1 indicates that capillary tubes bonded to filter dryer shells without couplings will pull free with unacceptably low force.

TABLE 2
Shear Strength

| | |
|---|---|
| conditions | No couplings on either tube. Samples gripped by eliminator |
| | tube and filter shell distal portion. |

| | strength | |
|---|---|---|
| sample | (lbf) | failure mode |
| 1 | 105 | Eliminator tube pulled free of shell. Adhesive failure. |
| 2 | 73 | Eliminator tube pulled free of shell. Adhesive failure. |
| 3 | 160 | Eliminator tube pulled free of shell. Adhesive failure. |

TABLE 3
Shear Strength

| conditions | Coupling on capillary tube, no coupling on eliminator | |
|---|---|---|
| | tube. Samples gripped by capillary tube and eliminator tube. | |
| | strength | |
| sample | (lbf) | failure mode |
| 4 | 12 | Capillary tube secure. Eliminator tube pulled free |
| | | of shell. Adhesive failure. |
| 5 | 26 | Capillary tube secure. Eliminator tube pulled free |
| | | of shell. Adhesive failure. |
| 6 | 64 | Capillary tube secure. Eliminator tube pulled free |
| | | of shell. Adhesive failure. |

TABLE 4
Shear Strength

| | |
|---|---|
| conditions | Coupling on capillary tube, no coupling on eliminator |
| | tube. Samples gripped by the unfailed tube and filter |
| | shell distal portion at failed end. |

| | strength | |
|---|---|---|
| sample | (lbf) | failure mode |
| 4 | 231 | Capillary tube material broke leaving capillary |
| | | tube portion bonded within filter dryer shell. |
| | | Substrate failure. |
| 5 | 236 | Capillary tube material broke leaving capillary |
| | | tube portion bonded within filter dryer shell. |
| | | Substrate failure. |
| 6 | 235 | Capillary tube material broke leaving capillary |
| | | tube portion bonded within filter dryer shell. |
| | | Substrate failure. |

Table 3 indicates that capillary tubes bonded to filter dryer shells with couplings will not pull free from the shell. Table 4 indicates that the material of the capillary tube will break before the adhesive joint will fail.

TABLE 5
Leak and Burst Test

| | |
|---|---|
| conditions | No couplings on either tube. |

| | leak | Burst Test | |
|---|---|---|---|
| sample | test | pressure | failure mode |
| 7 | pass | 3072 | Filter dryer shell burst. Adhesive |
| | | | joints intact. |
| 8 | pass | >2614 | none. |
| 9 | pass | 2574 | Filter dryer shell burst. Adhesive |
| | | | joints intact. |

TABLE 6
Leak and Burst Test

| conditions | Coupling on capillary tube, no coupling on eliminator tube. | | |
|---|---|---|---|
| | leak | Burst Test | |
| sample | test | pressure | failure mode |
| 10 | pass | 1311 | Failure of eliminator tube joint. |
| 11 | pass | 2735 | Filter dryer shell burst. Adhesive |
| | | | joints intact. |
| 12 | pass | 1967 | Failure of eliminator tube joint. |

### Example 2

Sample Preparation

The adhesive used was a mixture of Parts A and B. A plurality of filter dryer shells; capillary tubes; eliminator tubes and couplings were provided. All parts were copper or copper alloy. Capillary tubes had a nominal outside diameter of about 0.08 inches and a length of about three inches. Eliminator tubes had a nominal outside diameter of about 0.2 inches and a length of about three inches. All surfaces to be bonded were cleaned with isopropyl alcohol and allowed to air dry.

Each capillary tube was marked ⅜ (0.375) inches from an end. This was the bond area. Each eliminator tube was marked ⅜ (0.375) inches from an end.

Adhesive was dispensed onto each tube along the measured 0.375 inch bond area. Approximately 0.005 grams to 0.01 grams of adhesive was used for each capillary tube bond area. Approximately 0.02 grams of adhesive was used for each eliminator tube bond area.

If appropriate, the tube was disposed within the bore of a coupling so that the larger diameter bore of the coupling faced the free end of the bond area but was more than 0.375 inches from that fee end. Adhesive was dispensed into the larger diameter bore of the coupling and onto the capillary tube along the measured one inch length. Approximately 0.03 grams of adhesive was used for each capillary coupling bore. Approximately 0.06 grams to 0.07 grams of adhesive was used in each eliminator coupling bore.

Each tube was inserted into the filter dryer shell up to the 0.375 inch mark. For test specimens not using a capillary tube coupling this provided a structure comprising an inner tube, a layer of adhesive, and the filter dryer distal portion.

If appropriate the coupling was pressed over the distal end of the filter dryer shell, to provide a structure comprising an inner tube, a layer of adhesive, the filter dryer distal portion, a layer of adhesive and the coupling.

Samples were allowed to cure for at least 48 hours under standard laboratory conditions before further testing. Results of testing on these samples is shown in the Table below.

TABLE 7
Shear Strength

| | |
|---|---|
| conditions | No couplings on either tube. Samples gripped by capillary |
| | tube and eliminator tube. |

| | strength | |
|---|---|---|
| sample | (lbf) | failure mode |
| 13 | 20 | Capillary tube pulled free of shell. Adhesive failure. |
| 14 | 45 | Capillary tube pulled free of shell. Adhesive failure. |

TABLE 8
Shear Strength

| | |
|---|---|
| conditions | No couplings on either tube. Samples gripped by eliminator |
| | tube and filter shell distal portion. |

| | strength | |
|---|---|---|
| sample | (lbf) | failure mode |
| 13 | 152 | Eliminator tube pulled free of shell. Adhesive failure. |
| 14 | 166 | Adhesive failure. |

TABLE 9
Shear Strength

| | |
|---|---|
| conditions | Couplings on both capillary and eliminator tube. Samples |
| | gripped by capillary tube and eliminator tube. |

| | strength | |
|---|---|---|
| sample | (lbf) | failure mode |
| 15 | 118 | Capillary tube pulled free of shell. Adhesive failure. |
| 16 | 166 | Capillary tube pulled free of shell. Adhesive failure. |

TABLE 10
Shear Strength

| conditions | | Couplings on both capillary and eliminator tube. Samples | |
|---|---|---|---|
| | | gripped by remaining tube and filter shell distal portion on | |
| | | failed side. | |
| | | strength | |
| | sample | (lbf) | failure mode |
| | 15 | 296 | Eliminator tube pulled free of shell. |
| | | | Adhesive failure. |
| | 16 | 322 | Eliminator tube pulled free of shell. |
| | | | Adhesive failure. |

TABLE 11
Leak and Burst Test

| | |
|---|---|
| conditions | Couplings on both capillary and eliminator tubes. |

| | leak | Burst Test | |
|---|---|---|---|
| sample | test | pressure | failure mode |
| 17 | pass | 2416 | Filter dryer shell burst. Adhesive |
| | | | joints intact. |
| 18 | pass | 1170 | Failure of eliminator tube joint. |
| 19 | pass | 2481 | Filter dryer shell burst. Adhesive |
| | | | joints intact. |
| 20 | pass | 2460 | Filter dryer shell burst. Adhesive |
| | | | joints intact. |

### Example 3

Sample Preparation

The adhesive used was a mixture of Parts A and B. Parts were prepared as in Example 2 except that the eliminator tube material is aluminum. An average of 0.12 gms of adhesive was used to form the capillary tube bond with a coupling and 0.04 gms without a coupling. An average of 0.10 gms of adhesive was used to form the eliminator tube bond with a coupling and 0.04 gms without a coupling. Average diametrical gap between the dryer shell end inside diameter and eliminator tube outside diameter is 0.009 inches. Average diametrical gap between the dryer shell end inside diameter and capillary tube outside diameter is 0.009 inches. Results of testing on these samples is shown in the Table below.

TABLE 12
Shear Strength

| | couplings | strength | |
|---|---|---|---|
| sample | used? | (lbf) | failure mode |
| 21 | yes | 426 | capillary tube material failed |
| 22 | yes | 426 | capillary tube material failed |
| 23 | no | 93 | cohesive failure at capillary tube bond |
| 24 | no | 64 | adhesive failure at eliminator tube bond |
| 25 | yes | 236 | capillary tube material failed |
| 26 | yes | 236 | capillary tube material failed |
| 27 | no | 104 | cohesive failure at capillary tube bond |
| 28 | no | 78 | cohesive failure at capillary tube bond |

TABLE 13
Leak and Burst Test

| | couplings | leak | Burst Test | |
|---|---|---|---|---|
| sample | used? | test | pressure | failure mode |
| 29 | yes | pass | 3270 | dryer body burst |
| 30 | yes | pass | 3293 | dryer body burst |
| 31 | no | pass | 3113 | adhesive failure at eliminator |
| | | | | tube bond |
| 32 | no | pass | 3101 | adhesive failure at eliminator |
| | | | | tube bond |
| 33 | yes | pass | 3465 | dryer body burst |
| 34 | yes | pass | 3537 | dryer body burst |
| 35 | no | pass | 3527 | adhesive failure at eliminator |
| | | | | tube bond |
| 36 | no | pass | 3532 | dryer body burst |

As shown in Table 12 high pressure connections made without a coupling were considerably weaker than high pressure connections made using a coupling and further have less desirable failure modes. The high pressure connections made without a coupling would not be desirable for use in a HVAC system. While the burst pressure was similar for both types of connections a difference is seen in their failure modes, with high pressure connections made using a coupling having more desirable failure modes.

What is claimed:

1. A method of making a high pressure connection, the connection consisting essentially of a first tubular member, a second tubular member, a coupling and cured reaction products of a radically curable composition, comprising:
providing the first tubular member having a distal joint portion;
providing the second tubular member having a distal joint portion;
providing the coupling having a bore therethrough,
applying a radically curable composition to at least one of the distal joint portions and coupling;
sliding the second tubular member distal joint portion into the coupling bore;
sliding the first tubular member distal joint portion into the coupling bore; and
curing the curable composition to maintain the first and second tubular member distal joint portions within the coupling bore thereby forming the high pressure connection.

2. The method of claim 1 wherein one of the first or second tubular members is aluminum and the other of the members is selected from copper, aluminum, steel, coated steel and plastic.

3. The method of claim 1 wherein the high pressure connection is part of a refrigeration system selected from a refrigerator, a freezer, a refrigerator-freezer, an air conditioner, an HVAC system or a heat pump.

4. The method of claim 1 further comprising applying a primer composition to at least one of the distal joint portions and coupling;

5. A refrigeration filter drier unit, comprising:
the filter dryer unit including a first tubular member having a first distal joint portion including a substantially cylindrical outer surface free from threads, a substantially cylindrical inner surface free from threads having an inner diameter defining a bore through the member, and a circumferential first end connecting the outer and inner surfaces;
a refrigerant line having a second distal joint portion including a substantially uniform cylindrical outer surface free from threads and defining an outer diameter smaller than the first member inner diameter, a substantially uniform cylindrical inner surface free from threads defining a bore through the member, and a circumferential second end connecting the outer and inner surfaces, the second distal joint portion disposed within the first distal joint portion, wherein the outer diameter is substantially constant over the length of the second distal joint portion;
a coupling having opposing first and second ends and an inner surface defining a bore therethrough, the first member distal joint portion disposed within the coupling bore at the coupling first end and the second member distal joint portion disposed within the coupling bore at the coupling second end; and
a cured reaction product of a radically curable composition disposed between each distal joint portion and the coupling.

6. The refrigeration filter drier unit of claim 5 wherein the first tubular member and second tubular member are each independently selected from aluminum, copper, brass, steel, coated steel and plastic.

7. The refrigeration filter drier unit of claim 5 wherein there is no plastic deformation of the distal joint portions after the distal joint portions are disposed within the coupling.

8. The refrigeration filter drier unit of claim 5 wherein the cured reaction product bonds each distal joint portion outer surface to the coupling inner surface.

9. The refrigeration filter drier unit of claim 5 wherein the cured reaction product is a cured reaction product of an anaerobically curable composition.

10. A method of increasing shear strength of a high pressure connection, the connection consisting essentially of a first distal joint portion, a second distal joint portion, a coupling and cured reaction products of a radically curable composition, comprising:
providing the first distal joint portion;
providing the second distal joint portion;
providing the coupling having opposing ends and a bore therethrough,
applying a radically curable composition to at least one of the distal joint portions and coupling bore;
sliding the second distal joint portion into the coupling bore;
sliding the first distal joint portion into the coupling bore; and
curing the curable composition to maintain the first and second distal joint portions within the coupling bore to form the high pressure connection, wherein shear strength of the high pressure connection is increased over a high pressure connection made using the same distal joint portions and curable composition without the coupling.

11. The method of claim 10 wherein the high pressure connection remains impermeable to a refrigerant at a pressure of at least 2,000 pounds per square inch.

12. The method of claim 10 wherein first or second distal joint portions are independently selected from copper, copper alloy, aluminum, steel, coated steel and plastic.

13. The method of claim 10 wherein one of the first or second distal joint portions is a portion of a filter dryer unit and the other of the first or second distal joint portions is a refrigerant line.

14. The method of claim 10 wherein the radically curable composition is a two part composition and comprising the step of mixing separately stored parts of the radically curable composition prior to the step of applying the radically curable composition.
